(19) United States
(12) Patent Application Publication
(10) Pub. No.: US 2009/0052816 A1
(43) Pub. Date: Feb. 26, 2009

(54) WEAR PADS FOR HEAD YOKE PLATES

(76) Inventor: Robert U. WILLIAMSON, Dover, FL (US)

Correspondence Address: DEFILLO & ASSOCIATES, INC., P.O. Box 14104, Clearwater, FL, 33766, US

(21) Appl. No.: 12/193,290

(22) Filed: Aug. 18, 2008

Related U.S. Application Data
(60) Provisional application No. 60/965,710, filed on Aug. 22, 2007.

(51) Int. Cl. F16C 33/00

(52) U.S. Cl. 384/42

(57) ABSTRACT

The present invention relates to a wear pad system adapted to be used with a machine yoke. The system comprises: at least one shim, each shim having a first side and a second side, the first side in direct contact with the machine yoke; at least one shoe in direct contact with the second side of the shim, wherein each shoe has a plurality of openings through its length; at least one wear pad inserted on the openings of the shoe; at least one set of screws inserted on the openings of the shoe, wherein the screws are inserted into threaded holes of the machine yoke.

### REFERENCE TO RELATED APPLICATIONS

This application is a non-provisional of Provisional Application No. 60/965,710 filed Aug. 22, 2007, entitled “WEAR PADS FOR HEAD YOKE PLATES”.

### FIELD OF THE INVENTION

The present invention relates to machines for scoring and slotting corrugated board boxes, and more particularly, relates to a system that allows for an increase in the wear surface of the working parts.

### BACKGROUND OF THE INVENTION

Boxes or cartons are generally made from corrugated paperboard box blank sheets by the selective placement of scores, slots, and slits in the blank sheet. The prior art shows the use of scoring and slotting machines to impress score lines and cut slots in blank sheets of corrugated paperboard box blanks as the sheets are conveyed through the machine.

The prior art machines for forming box blanks show that the tool heads for slotting and scoring the blanks are mounted in matching positions on successive pairs of shafts. Each pair of shafts is oriented with one shaft above the other. Thus, the slotting and scoring operations take place serially as the blank is fed along a path on each set of mating tool heads on the paired shafts.

Precise scoring is critical to the perfect fit of the resulting box. Unfortunately, the continuous use of the machines produces misalignment of the units by the wear and tear of the parts.

To reduce and control any misalignment between the units during the process, the prior art includes the use of pads or bearings secured to the stationary parts in contact with the rotating parts.

On corrugated box making machines, commonly called “Flexos”, there is a yoke with replaceable, independent contact wear parts commonly called wear “buttons” which stay stationary and hold the slotter heads and score heads in their position while they rotate.

A disadvantage presented by the known wear buttons is that after sufficient wear, the buttons must be either replaced or repaired. In conventional slotting machines, the entire bushing is removed from the yoke and discarded even though only the ends, where the bushing contacts the rotating wheel, are worn.

Although improvements have been made by replacing the wear buttons (replacing only the end wear surface versus discarding the entire piece), there is still insufficient increase in the wear surface; thus, constant replacement of the parts is required.

In either repair or replacement, the correction is time consuming and expensive, due to the consequential loss of production time.

### SUMMARY OF THE INVENTION

It is, therefore, an objective of the present invention to provide a wear pad system that is both inexpensive to manufacture and requires little machine downtime to adjust.

It is another objective of the present invention to provide a wear pad system that increases the wear surface area of the pad.

It is another objective of the present invention to provide a wear pad system that can be adjusted in a few minutes rather than several hours.

It is another objective of the present invention to provide a wear pad system that is easy to install and does not require the use of complicated tools.

The wear pad system of the present invention is adapted to be used with a machine yoke. The system comprises:

at least one shim, each shim having a first side and a second side, the first side in direct contact with the machine yoke;

at least one shoe in direct contact with the second side of the shim, wherein each shoe has a plurality of openings through its length;

at least one wear pad inserted on the openings of the shoe;

at least one set of screws inserted on the openings of the shoe, wherein the screws are inserted into threaded holes of the machine yoke.

The foregoing detailed description is intended to be illustrative and non-limiting. Many changes and modifications are possible in light of the above teachings. Thus, it is understood that the invention may be practiced than as otherwise specifically described herein and still be within the scope of the appended claims.

### BRIEF DESCRIPTION OF THE DRAWINGS

For a more complete understanding of the nature and objectives of the present invention, reference should be made to the following detailed description taken together with the accompanying drawings, in which:

FIG. 1 is a perspective view of slotting machine showing the OEM buttons with the alignment wear plate removed.

FIG. 2 is a perspective view of the slotting machine showing the system according to the present invention.

FIG. 3 is a front view of the color coded shims according to the present invention.

FIG. 4 is a perspective view of the slotting machine illustrating the installation of special set screws of the present invention holding the shoes in place.

FIG. 5 is a front view of the slotting machine illustrating the shoes according to the present invention.

FIG. 6 is a front view of the shoes according to the present invention.

FIG. 7 is a front view of all the elements of the system according to the present invention.

FIG. 8 is a perspective view of the system according to the present invention showing the shoes with wear pads installed, shim in place under shoe and sitting on the special set screws as it would look installed on the machines yoke.

### DETAILED DESCRIPTION OF THE INVENTION

The present invention replaces these independent wear buttons of the prior art with a system that allows a significant increase in wear surface. The present system allows for replaceable shims between the shoes and the surface of the yoke that allow the shoes to be moved outward in small increments to maintain the correct clearance between the contact surfaces as they wear with very minimal product and labor costs.

The wear pad system 10 according to the present invention is adapted to be used with a machine yoke. The system 10 comprises:

at least one shim 20, each shim having a first side 30 and a second side 40 and a plurality of openings 45 through its length, the first side 30 of the shim adapted to be in direct contact with the machine yoke 50;

at least one shoe 60 in direct contact with the second side 40 of the shim 20, wherein each shoe 60 has a plurality of openings 70 through its length;

at least one wear pad 80 inserted on the openings 70 of the shoe 60;

at least one set of screws 90 inserted on the openings 45 of the shim 20, wherein the screws 90 are inserted into threaded holes 100 on the machine yoke 50.

### Shims

The shims 20 are half disk-shaped in the exemplary embodiment described below, but may be manufactured in other shapes and sizes as a matter of design choice.

Extending through the shim 20 at various points are openings 45 spaced in such a manner to conform to the spacing between the threaded holes 100 on the machine yoke 50.

Because the shim 20 sets the running clearances, it is important that the material of the shim have a very high compressive strength at yield. In addition, the material of the shim must have a much lower coefficient of thermal expansion than steel. In view of the above, the shim of the present invention is preferably formed of a plastic material which is yieldably compressible, especially a synthetic resin.

It is to be understood that any resiliently compressible non-metallic materials, especially synthetic resin or plastic materials, which are capable of performing the desired functions may be used.

In one embodiment of the present invention the shims are color coded to make the job easier.

The shims have a thickness between 0.005 to 0.020 inches. In addition, the shims have the same outside and inside diameter of the shoes of the machine size and model that they are being installed on.

### Shoes

The shoes 60 are half disk-shaped in the exemplary embodiment described below, but may be manufactured in other shapes and sizes as a matter of design choice. Extending through the shoes 60 at various points are openings 70 spaced through its length.

In the preferable embodiment, the shoe 60 is made of a laminated plastic chosen from the family of garolite, which is a phenolic material. For example, the shoe 60 may comprise the material known as Garolite 10, available from the McMaster-Carr Supply Co., located in Elmhurst, Ill. This material consists of continuous, woven glass fabric laminated with epoxy resin formed under pressure and heat. Garolite 10 exhibits excellent tensile strength (up to 10,000 psi), electrical insulation properties (500 volts per 0.001 inch thickness), and impact strength (5 foot pounds of energy per inch of thickness, under normal conditions). This material is also said to function well between 0° and 284° Fahrenheit.

In addition, Garolite 10 is lightweight and is resistant to heat, moisture, chemicals, oil, corrosive solutions, acids alkalis, and solvents.

An advantage of making the shoes of garolite 10 is that there are no longer any metallic wear parts running in-between the steel machine wear plates that need to maintain a smooth surface of 5 to 7 rms; thus, the damage to these expensive pieces is reduced and the life of the wear pads buttons is increased.

It is to be understood that any suitable non-metallic material which are capable of performing the desired functions of the shoe may be used.

The shoe style design also allows for special grinding/smoothing shoes that could be temporarily installed, in which the shoes' surfaces are coated with various abrasive materials, such as diamond dust, that would allow it to smooth the surfaces of the machine contact wear parts. With the grinding/smoothing shoes installed, the machine would be operated with contact surface rotation for an amount of time needed to grind the surfaces smooth again. This would save time and cost on the replacement of these parts.

The shoes are manufactured having a thickness of at least 0.125 inch. Furthermore, the shoes have the same outside and inside diameter of the machine's yoke assembly of the machine size and model that they are being installed on. The thickness can vary also according to the machine size and model.

### Wear Pads

The system according to the present invention also includes at least one wear pad 80 inserted on the openings 70 of the shoe 60.

The wear pads 80 are typically manufactured from carbon or a carbon impregnated polymeric material, such as NYLON® or TEFLON®. However, any suitable sacrificial material may be used, and the selection of a particular sacrificial material will be a design choice based on the particular machine configuration and operating parameters.

In addition, the particular wear pads are disk-shaped in the exemplary embodiment described below, but may be manufactured in other shapes and sizes as a matter of design choice. The wear pads size and thickness are manufactured to fit into the parameters of the size and model of the machine they being install. The ones shown are 1″ diameter and 0.140 thick for this machine model.

### Screws

Custom made set screws are installed into the existing threaded holes in the yoke. They have the same outside diameter of and threads per inch as the OEM Button of the machine size and model that the custom set screws are replacing.

In the preferable embodiment, the screws 90 are made of a laminated plastic chosen from the family of garolite, which is a phenolic material.

The system of the present invention allows for replaceable shims between the shoes and the surface of the yoke that allow the shoes to be moved outward, in thousands of an inch at a time, to maintain the correct clearance between the contact surfaces as they wear with very minimal cost and labor cost. The existing method requires the replacing of the single contact items as they wear. The shoe style design can be made of all kinds of material and the contact surface can be increased or decreased as to the customer's needs.

The system according to the present invention requires no special tools to adjust it, just remove and add thicker or thinner shims as needed to set the required clearances between the slotter and score head wear surfaces and the shoes. The shims are plastic and are color coded to make the job easier. Custom made set screws are installed into the existing threaded holes in the yoke from which the wear buttons are removed. A shim is installed over the stud portion of the set screw, which protrudes from the yoke and supports the shim and shoe. Next shoes are installed, the head is reassembled, clearances are checked between the wear surfaces, and conversion is finished.

The system utilizes the original OEM machine without any modifications. The system of the present invention can be made of various materials and the contact surface can be increased or decreased to suit the customer's needs.

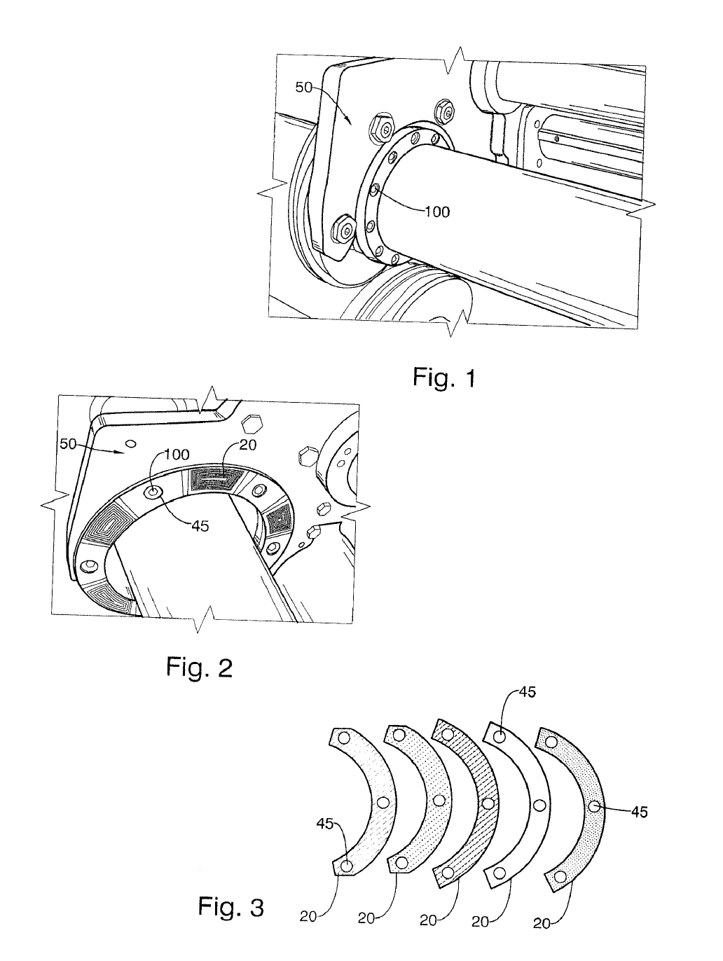

FIG. 1 shows the slotting machine showing the OEM buttons with the alignment wear plate removed.

FIG. 2 shows the slotting machine showing the system according to the present invention in which the shoe style design installed on new custom set screws that replaced the OEM Carbon Buttons.

FIG. 3 shows color coated shims that are installed between machine yoke and shoe to set clearances between contact surfaces.

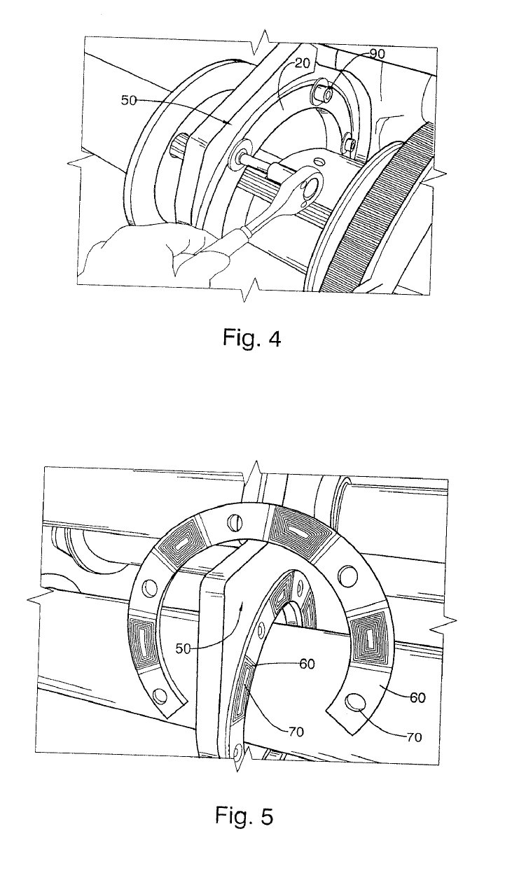

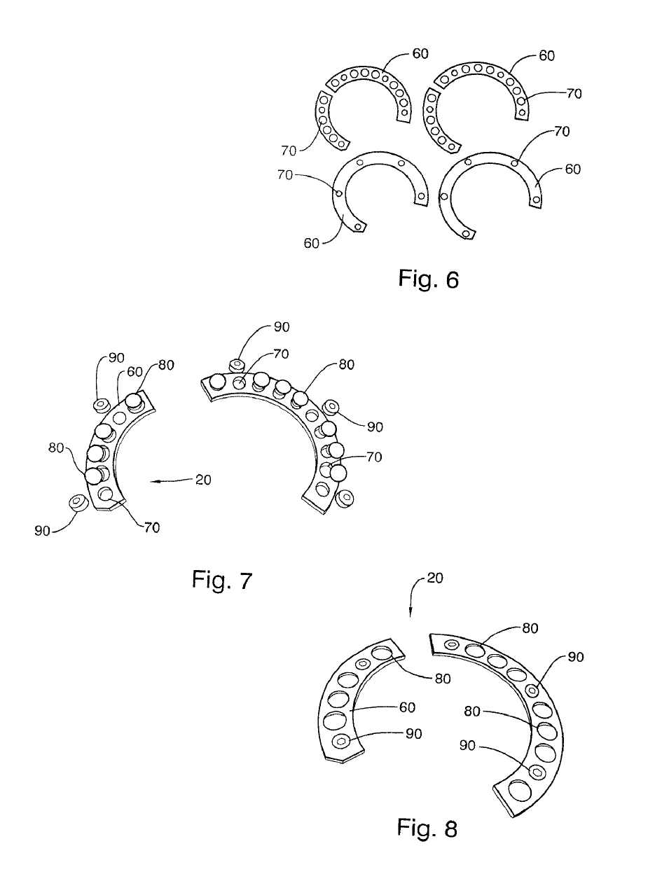

FIG. 4 shows the installation of special set screws to hold shoes in place.

FIG. 5 shows the slotting machine illustrating the shoes according to the present invention. One of the shoes is shown in place on the yoke and another of the shoes is shown hanging.

FIG. 7 shows a picture of all the pieces, the special set screw, shim and shoes without wear pads installed.

FIG. 8 shows the system according to the present invention showing the shoes with wear pads installed, shim in place under shoe and sitting on the special set screws as it would look installed on the machines yoke.

### Benefits of the Present Invention:

Significant increase in wear surface (at least 375% more than OEM);

Reduced downtime and maintenance costs from less frequent changes in wear surfaces;

Less maintenance from freedom of changing individual buttons;

Simple installation of shoe system and changing of shims—only simple hand tools are required for complete installation;

Once heads are separated, no tools are required to shim the shoes;

No modification of the original manufacturer's machine is necessary;

Extended wear life of plates; and

Extended wear life of tooling.

Many modifications and other embodiments of the invention set forth herein will come to mind to one skilled in the art to which this invention pertains, having the benefit of the teachings presented in the foregoing descriptions and the associated drawings. Therefore, it is to be understood that the invention is not to be limited to the specific embodiments disclosed, and that modifications and other embodiments are intended to be included within the scope of the appended claims. Although specific terms are employed herein, they are used in a generic and descriptive sense only, and not for purposes of limitation.

What is claimed is:

1. A wear pad system adapted to be used with a machine yoke, the system comprising:
at least one shim, each shim having a first side, a second side, and a plurality of openings through its length, the first side adapted to be in direct contact with the machine yoke;
at least one shoe in direct contact with the second side of the shim, wherein each shoe has a plurality of openings through its length;
at least one wear pad inserted on the openings of the shoe;
at least one set of screws inserted on the openings of the shim, wherein the screws are inserted into threaded holes on the machine yoke.

2. The wear pad system of claim 1, wherein each set of wear pads have different thickness.

3. A machine yoke comprising:
a wear pad system including:
at least one shim, each shim having a first side, a second side, and a plurality of openings through its length, the first side adapted to be in direct contact with the machine yoke;
at least one shoe in direct contact with the second side of the shim, wherein each shoe has a plurality of openings through its length;
at least one wear pad inserted on the openings of the shoe;
at least one set of screws inserted on the openings of the shim, wherein the screws are inserted into threaded holes on the machine yoke.

4. The wear pad system of claim 1, wherein the shims are color coded.

5. The wear pad system of claim 1, wherein the shoes are made of garolite.

6. The wear pad system of claim 1, wherein the screws are made of garolite.
